(19) United States
(12) Patent Application Publication
(10) Pub. No.: US 2026/0140970 A1
(43) Pub. Date: May 21, 2026

(54) ELECTRONIC DEVICE AND CONTROLLING METHOD THEREOF

(71) Applicant: Samsung Electronics Co., Ltd., Suwon-si (KR)

(72) Inventors: Jooyeon KIM, Suwon-si (KR); Hyonsok LEE, Suwon-si (KR); Jiyun DO, Suwon-si (KR); Jongmoon KIM, Suwon-si (KR); Yuree KIM, Suwon-si (KR)

(21) Appl. No.: 19/392,567

(22) Filed: Nov. 18, 2025

Related U.S. Application Data
(63) Continuation of application No. PCT/KR2025/017468, filed on Oct. 29, 2025.

(30) Foreign Application Priority Data
Nov. 15, 2024 (KR) 10-2024-0163575

(51) Int. Cl. G06F 16/30; G06F 16/23; G06F 40/30

(52) U.S. Cl. CPC G06F 16/30; G06F 16/2358; G06F 40/30

(57) ABSTRACT

An electronic device and a controlling method thereof are provided. The electronic device includes memory, including one or more storage media, storing instructions, and at least one processor communicatively coupled to the memory, wherein the instructions, when executed by the at least one processor individually or collectively cause the electronic device to, based on receiving a request for data analysis, identify subject data for analysis corresponding to the request and an algorithm used in the data analysis, identify a schema corresponding to the subject data for analysis among a plurality of schemas related to a structure of a database constructed in advance, obtain an analysis result that corresponds to the identified schema and is related to the subject data for analysis from the database by using the identified algorithm, and provide the analysis result.

### CROSS-REFERENCE TO RELATED APPLICATION(S)

This application is a continuation application, claiming priority under 35 U.S.C. § 365(c), of an International application No. PCT/KR 2025/017468, filed on Oct. 29, 2025, which is based on and claims the benefit of a Korean patent application number 10-2024-0163575, filed on Nov. 15, 2024, in the Korean Intellectual Property Office, the disclosure of which is incorporated by reference herein in its entirety.

### BACKGROUND

### 1. Field

The disclosure relates to an electronic device and a controlling method of the electronic device. More particularly, the disclosure relates to an electronic device that can perform data analysis and provide an analysis result, and a controlling method thereof.

### 2. Description of Related Art

Recently, as miniaturization and high integration of electronic devices have been achieved, and technologies related to artificial intelligence have developed, various types of services are being provided to users. For example, a user can be provided with information on his/her exercise record through applications, such as a smartphone, a smart watch, or the like, or can be provided with various analysis results related to his/her exercise record.

In providing various types of services to a user, a process of collecting and analyzing data to be used for the services is needed. Meanwhile, there may be differences in the types of each service, and there may also be differences in the schemas of data for providing each service and methods of collecting data for providing each service.

According to a technology of the related art, in case a service provided to a user is changed, or an algorithm applied to data analysis or a model implementing the algorithm (e.g., a neural network model) is changed, or the like, the developer resolves the problem by a method, such as manually changing the content and the schema of service data for providing the service, and updating an application provided to the user for reflecting the changes, and updating data or a program for implementing the service at a server, or the like.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device that can automatically reflect change of a database to service data for providing a service, and provide a data analysis result appropriate for the provided service, and a controlling method thereof.

Additional aspects will be set forth in part in the description which follows and, in part, will be apparent from the description, or may be learned by practice of the presented embodiments.

In accordance with an aspect of the disclosure, an electronic device is provided. The electronic device includes memory, including one or more storage media, storing instructions, and at least one processor communicatively coupled to the memory, wherein the instructions, when executed by the at least one processor individually or collectively cause the electronic device to, based on receiving a request for data analysis, identify subject data for analysis corresponding to the request and an algorithm used in the data analysis, identify a schema corresponding to the subject data for analysis among a plurality of schemas related to a structure of a database constructed in advance, obtain an analysis result that corresponds to the identified schema and is related to the subject data for analysis from the database by using the identified algorithm, and provide the analysis result.

Meanwhile, the request includes text information input by a user, and the processor identifies the subject data for analysis and the algorithm used in the data analysis based on the text information.

Meanwhile, the instructions, when executed by the at least one processor individually or collectively further cause the electronic device to, based on the text information including information on one algorithm among a plurality of pre-defined algorithms, identify the one algorithm as the algorithm used in the data analysis, and based on the text information not including information on one algorithm among the plurality of algorithms, obtain information on the user's intent included in the text information by inputting the text information into a trained language model, and based on the information on the user's intent, identify the algorithm used in the data analysis.

Meanwhile, the instructions, when executed by the at least one processor individually or collectively further cause the electronic device to, based on the information on the user's intent, identify data corresponding to the request.

Meanwhile, the plurality of respective algorithms is performed by a plurality of analysis models including a neural network, and the instructions, when executed by the at least one processor individually or collectively further cause the electronic device to obtain the analysis result by inputting information on the subject data for analysis and the identified schema into an analysis model corresponding to the identified algorithm among the plurality of analysis models.

Meanwhile, the electronic device further includes a communication interface, and the instructions, when executed by the at least one processor individually or collectively further cause the electronic device to receive the request from a user terminal through the communication interface, and based on obtaining the analysis result, provide the analysis result by controlling the communication interface to transmit the analysis result to the user terminal.

Meanwhile, the instructions, when executed by the at least one processor individually or collectively further cause the electronic device to obtain resource information related to a configuration of a user interface for displaying the analysis result on the user terminal, and control the communication interface to transmit the resource information to the user terminal.

Meanwhile, the plurality of schemas corresponds to at least one of a plurality of services provided through the user terminal, and the instructions, when executed by the at least one processor individually or collectively further cause the electronic device to, based on detecting a change for the database, update service data for the plurality of services by generating data corresponding to each of the plurality of schemas based on the changed database.

In accordance with another aspect of the disclosure, a method of controlling an electronic device is provided. The method includes, based on receiving a request for data analysis, identifying subject data for analysis corresponding to the request and an algorithm used in the data analysis, identifying a schema corresponding to the subject data for analysis among a plurality of schemas related to a structure of a database constructed in advance, obtaining an analysis result that corresponds to the identified schema and is related to the subject data for analysis from the database by using the identified algorithm, and providing the analysis result.

Meanwhile, the request includes text information input by a user, and the identifying the subject data for analysis and the algorithm includes the operation of identifying the subject data for analysis and the algorithm used in the data analysis based on the text information.

Meanwhile, the identifying the subject data for analysis and the algorithm includes, based on the text information including information on one algorithm among a plurality of pre-defined algorithms, identifying the one algorithm as the algorithm used in the data analysis, and based on the text information not including information on one algorithm among the plurality of algorithms, obtaining information on the user's intent included in the text information by inputting the text information into a trained language model, and based on the information on the user's intent, identifying the algorithm used in the data analysis.

Meanwhile, the identifying the subject data for analysis and the algorithm includes, based on the information on the user's intent, identifying data corresponding to the request.

Meanwhile, the plurality of respective algorithms is performed by a plurality of analysis models including a neural network, and the obtaining the analysis result includes the obtaining the analysis result by inputting information on the subject data for analysis and the identified schema into an analysis model corresponding to the identified algorithm among the plurality of analysis models.

Meanwhile, the method of an electronic device further includes receiving the request from a user terminal, and the providing the analysis result includes the operation of, based on obtaining the analysis result, transmitting the analysis result to the user terminal.

Meanwhile, the method of an electronic device further includes obtaining resource information related to a configuration of a user interface for displaying the analysis result on the user terminal, and transmitting the resource information to the user terminal.

Meanwhile, the plurality of schemas corresponds to at least one of a plurality of services provided through the user terminal, and the method of an electronic device further includes, based on detecting a change for the database, updating service data for the plurality of services by generating data corresponding to each of the plurality of schemas based on the changed database.

In accordance with another aspect of the disclosure, one or more non-transitory computer-readable storage media storing one or more computer programs including computer-executable instruction that, when executed by one or more processors of an electronic device individually or collectively, cause the electronic device to perform operations are provided. The operations include based on receiving a request for data analysis, identifying subject data for analysis corresponding to the request and an algorithm used in the data analysis, identifying a schema corresponding to the subject data for analysis among a plurality of schemas related to a structure of a database constructed in advance, obtaining an analysis result that corresponds to the identified schema and is related to the subject data for analysis from the database by using the identified algorithm, and providing the analysis result.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram schematically illustrating a configuration of an electronic device according to an embodiment of the disclosure;

FIG. 2 is a block diagram illustrating a configuration of an electronic device according to an embodiment of the disclosure;

FIG. 3 is a diagram illustrating a method of providing an analysis result according to an embodiment of the disclosure;

FIG. 4 is a diagram illustrating a method of providing an analysis result by using a language model and an analysis model according to an embodiment of the disclosure;

FIGS. 5 and 6 are diagrams illustrating a user interface according to various embodiments of the disclosure; and

FIG. 7 is a diagram illustrating a controlling method of an electronic device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In addition, in the disclosure, expressions, such as “have,” “may have,” “include,” and “may include” denote the existence of such characteristics (e.g., elements, such as numbers, functions, operations, and components), and do not exclude the existence of additional characteristics.

In addition, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

Further, the expressions “first,” “second,” and the like used in the disclosure may describe various elements regardless of any order and/or degree of importance. In addition, such expressions are used only to distinguish one element from another element, and are not intended to limit the elements.

Meanwhile, the description in the disclosure that one element (e.g., a first element) is “(operatively or communicatively) coupled with/to” or “connected to” another element (e.g., a second element) should be interpreted to include both the case where the one element is directly coupled to the another element, and the case where the one element is coupled to the another element through still another element (e.g., a third element).

In contrast, the description that one element (e.g., a first element) is “directly coupled” or “directly connected” to another element (e.g., a second element) can be interpreted to mean that still another element (e.g., a third element) does not exist between the one element and the another element.

In addition, the expression “configured to” used in the disclosure may be interchangeably used with other expressions, such as “suitable for,” “having the capacity to,” “designed to,” “adapted to,” “made to,” and “capable of,” depending on cases. Meanwhile, the term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g., an embedded processor) for performing the corresponding operations, or a generic-purpose processor (e.g., a CPU or an application processor) that can perform the corresponding operations by executing one or more software programs stored in a memory device.

In addition, in the embodiments of the disclosure, ‘a module’ or ‘a part’ may perform at least one function or operation, and may be implemented as hardware or software, or as a combination of hardware and software. In addition, a plurality of ‘modules’ or ‘parts’ may be integrated into at least one module and implemented as at least one processor, excluding ‘a module’ or ‘a part’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

Hereinafter, the embodiments according to the disclosure will be described with reference to the accompanying drawings, such that those having ordinary skill in the art to which the disclosure belongs can easily carry out the disclosure.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

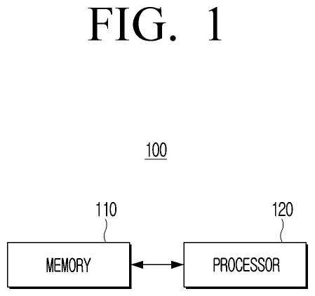

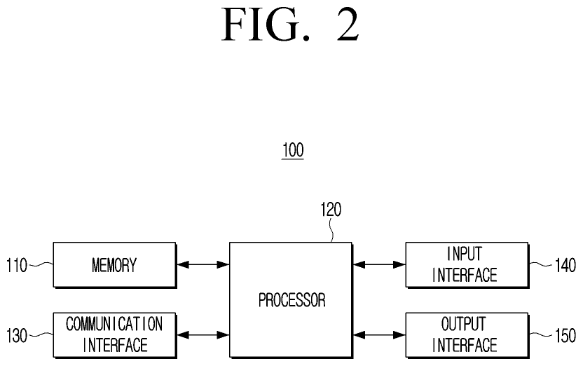

FIG. 1 is a block diagram schematically illustrating a configuration of an electronic device according to an embodiment of the disclosure, and FIG. 2 is a block diagram illustrating a configuration of an electronic device according to an embodiment of the disclosure.

Referring to FIG. 1, an electronic device 100 may include memory 110 and a processor 120. Referring to FIG. 2, the electronic device 100 may further include a communication interface 130, an input interface 140, and an output interface 150. However, it is obvious that in carrying out the disclosure, new components can be added in addition to the components as illustrated in FIGS. 1 and 2, or some components can be omitted.

‘The electronic device 100’ according to the disclosure refers to a device that can provide an analysis result by performing data analysis. In addition, the electronic device 100 can provide various types of services to a user. In the disclosure, ‘a service’ generally refers to a function of providing information on a user, or providing various analysis results together with information on a user.

For example, the electronic device 100 may be a server that is for managing a database, and providing an analysis result and a service. However, there is no special limitation on the type of the electronic device 100 according to the disclosure.

In the memory 110, at least one instruction related to the electronic device 100 may be stored. In addition, in the memory 110, an operating system (O/S) for driving the electronic device 100 may be stored. In addition, in the memory 110, various kinds of software programs or applications for the electronic device 100 to operate according to the various embodiments of the disclosure may be stored. Further, the memory 110 may include semiconductor memory, such as flash memory or a magnetic storage medium, such as a hard disk, or the like.

Specifically, in the memory 110, various kinds of software modules for the electronic device 100 to operate according to the various embodiments of the disclosure may be stored, and the processor 120 may control the operations of the electronic device 100 by executing the various kinds of software modules stored in the memory 110. For example, the memory 110 may be accessed by the processor 120, and reading/recording/correction/deletion/update, or the like, of data by the processor 120 may be performed.

Meanwhile, in the disclosure, the term memory 110 may be used as a meaning including the memory 110, read only memory (ROM) and random access memory (RAM) inside the processor 120, or memory card (e.g., a micro secure digital (SD) card, memory stick) installed on the electronic device 100.

According to an embodiment of the disclosure, in the memory 110, various types of data, such as a database, subject data (or target data) for analysis, and service data may be stored. In addition, in the memory 110, various types of information, such as information on an algorithm, information on a neural network model, information on a plurality of schemas, resource information, or the like, may be stored. The definition and the types of each data/information will be described later.

Other than the above, various types of information that is necessary within a range for achieving the purpose of the disclosure may be stored in the memory 110, and the information stored in the memory 110 may be updated as it is received from an external device or input by a user.

The processor 120 controls the overall operations of the electronic device 100. Specifically, the processor 120 may be connected with the components of the electronic device 100 including the memory 110, and control the overall operations of the electronic device 100 by executing the at least one instruction stored in the memory 110 as described above.

The processor 120 may be implemented by various methods. For example, the processor 120 may be implemented as at least one of an application specific integrated circuit (ASIC), an embedded processor, a microprocessor, a hardware control logic, a hardware finite state machine (FSM), or a digital signal processor (DSP). Meanwhile, in the disclosure, the term processor 120 may be used as a meaning including a central processing unit (CPU), a graphics processing unit (GPU), and a micro processor unit (MPU), or the like.

According to an embodiment of the disclosure, the processor 120 may provide an analysis result by performing data analysis.

The processor 120 may receive a request for data analysis. ‘A request for data analysis’ generally refers to a request for analysis of data to be provided to a user, and specifically, it may include a request for analysis of data included in a database and a request for provision of an analysis result. In addition, a request for data analysis may request change of data to be provided to a user according to change of an application or change of a service.

Here, ‘a database’ generally refers to various types of data that can be provided to a user, and refers to a collection of all types of data that can be used in data analysis. For example, a database may include data collected as a plurality of users use user terminals, data input by a user or the developer, and statistical data for a plurality of users, and may also include data that processed the data as above by various methods.

Specifically, the processor 120 may receive a request for data analysis based on a predetermined event occurred in the electronic device 100, or receive a request for data analysis from a user terminal. A request for data analysis received from a user terminal may be a request according to a user input, or a request according to a pre-defined application programming interface (API).

In addition, the processor 120 may receive a voice signal according to a user's utterance or text information input by a user, and identify a request for data analysis by analyzing the voice signal or the text information. For example, if a voice signal according to a user's utterance is received, the processor 120 may obtain text information corresponding to the voice signal by inputting the received voice signal into a trained voice recognition model. Then, the processor 120 may obtain a request for data analysis by inputting the text information into a trained natural language understanding model.

When a request for data analysis is received, the processor 120 may identify subject data for analysis corresponding to the request for data analysis and an algorithm used in the data analysis. Here, ‘the subject data for analysis’ refers to data which is a subject for analysis, and specifically, it may include data necessary for data analysis according to a request.

Specifically, the processor 120 may identify what the subject data for analysis is based on a request for data analysis, and may also identify an algorithm appropriate for performing the data analysis according to the request among a plurality of pre-defined algorithms. For example, the processor 120 may identify that the subject data for analysis is “statistics of the same age group for a pedometer,” and for data analysis, an algorithm A is appropriate among a pre-defined algorithm A, a pre-defined algorithm B, and a pre-defined algorithm C.

According to an embodiment of the disclosure, in case a request for data analysis includes text information input by a user, the processor 120 may identify subject data for analysis and an algorithm used in the data analysis based on the text information.

If the text information includes information on one algorithm among a plurality of pre-defined algorithms, the processor 120 may identify the one algorithm as the algorithm used in the data analysis.

In contrast, if the text information does not include information on one algorithm among the plurality of algorithms, the processor 120 may obtain information on the user's intent included in the text information by inputting the text information into a trained language model. Then, based on the information on the user's intent, the processor 120 may identify the algorithm used in the data analysis.

Meanwhile, the processor 120 may obtain information on the user's intent included in the text information by inputting the text information into the trained language model, and identify data corresponding to the request for data analysis, i.e., subject data for analysis based on the information on the user's intent.

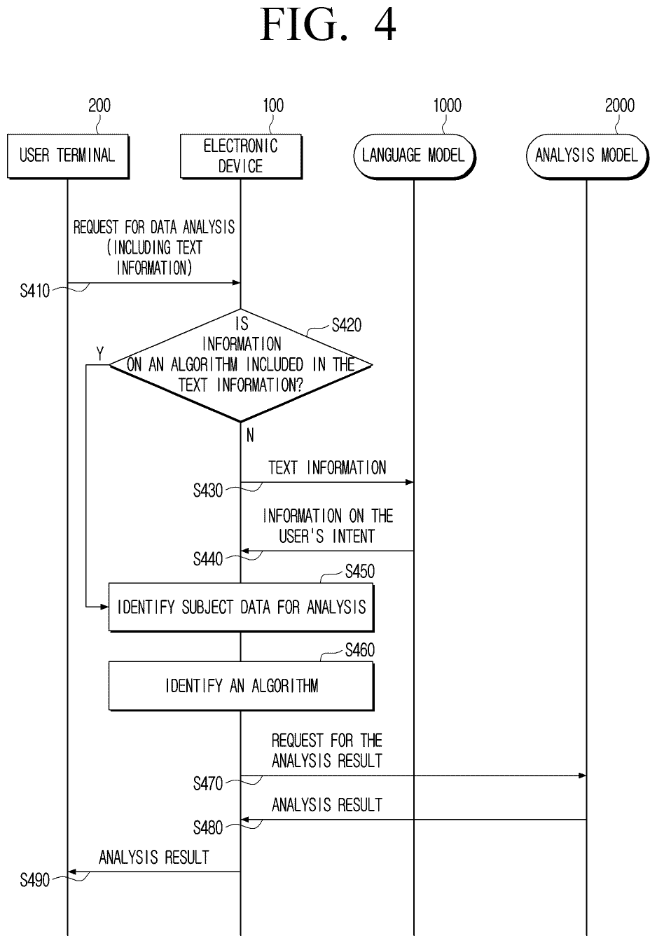

A process of identifying an algorithm used in data analysis based on text information or information on a user's intent, and a process of identifying subject data for analysis based on the information on the user's intent will be described with reference to FIG. 4.

The processor 120 may identify a schema corresponding to the identified data among a plurality of schemas related to a structure of a database constructed in advance.

‘A schema’ refers to a frame that defines a structure of data in a database, and it may include information on the logical structure and the relation of objects within the database. For example, a schema may include a table that stores data in a form of rows and columns, attributes of each row and each column, an index for data search, and constraints for maintaining the integrity of the data, or the like. The term ‘a schema’ may be replaced by a term, such as ‘a data structure’ or ‘a data model,’ or the like.

The plurality of schemas may be defined in advance to correspond to at least one among a plurality of services provided through a user terminal. For example, a first schema among the plurality of schemas may correspond to a service which is ‘providing a health score of a user,’ and a second schema among the plurality of schemas may correspond to two services which are ‘analyzing a sleeping record of a user’ and ‘providing a wake-up alarm.’

Specifically, the processor 120 may identify a schema including attributes related to subject data for analysis among the plurality of schemas. For example, in case data corresponding to a request for data analysis is “a running distance of a user,” the processor 120 may identify a schema corresponding to a table including attributes related to a running distance of a user among the plurality of schemas.

The processor 120 may obtain an analysis result that corresponds to the identified schema and is related to the identified data from the database by using the identified algorithm, and provide the analysis result. Here, ‘the analysis result’ refers to a result of analysis that was performed according to a request for data analysis, and may be obtained such that it is related to the data corresponding to the request for data analysis, and also corresponds to the identified schema. For example, the analysis result may include information related to the user (user information), information on analysis of other users (statistical information), information on a result of comparison between the information related to the user and the information on analysis of other users, or the like.

Specifically, the processor 120 may identify data including the identified schema from the database constructed in advance, and obtain an analysis result by using the relation between the data including the identified schema and the subject data for analysis. As in the aforementioned example, in case data corresponding to a request for data analysis is “a running distance of a user,” and a schema corresponding thereto includes “a table including attributes related to a running distance,” the processor 120 may obtain “an analysis result indicating the relation between the running distance of the user and the weight loss” from the database.

In the disclosure, what kind of analysis result is to be obtained by using what kind of analysis method may vary according to an algorithm used in data analysis, and in case an algorithm is implemented by using a neural network model, it may vary according to the neural network model. Hereinafter, a neural network model implementing an identified algorithm will be referred to as ‘an analysis model.’

According to an embodiment of the disclosure, a plurality of respective algorithms may be performed by a plurality of analysis models. In this case, the processor 120 may obtain an analysis result by inputting subject data for analysis and information on an identified schema into an analysis model corresponding to an identified algorithm among the plurality of analysis models. ‘The analysis model’ may be trained to, if subject data for analysis and information an identified schema are input, obtain an analysis result by referring to the database. However, there is no special limitation on the type of the analysis model according to the disclosure.

Meanwhile, in the case of receiving a request for data analysis from a user terminal, the processor 120 may provide an analysis result by controlling the communication interface 130 to transmit the obtained analysis result to the user terminal.

In this case, the processor 120 may obtain resource information related to the configuration of a user interface for displaying the analysis result on the user terminal, and control the communication interface 130 to transmit the resource information to the user terminal.

Specifically, in the case of displaying an analysis result on a user terminal, the processor 120 may identify whether a change of the user interface (UI) is needed. Then, if it is identified that a change of the user interface is needed, the processor 120 may obtain resource information related to the configuration of the user interface, and control the communication interface 130 to transmit the resource information to the user terminal. Meanwhile, in the case of displaying an analysis result on a user terminal, the processor 120 may not perform a process of identifying whether a change of the user interface is needed, but control the communication interface 130 to transmit resource information stored in advance to the user terminal.

Here, ‘resource information’ refers to information related to the configuration of the user interface, and specifically, it may indicate which information is displayed in which location of the user interface for providing the respective services. For example, the resource information may include information on a text resource that can be provided through the user interface, an image resource, an audio resource, a video resource, the layout of the user interface, the style of the user interface, or the like. The term ‘resource information’ may be replaced by a term, such as ‘a resource file,’ or the like.

For example, while a first user interface is being displayed on a user terminal, if a request for data analysis is received, the processor 120 may identify whether a change of the user interface is needed in the case of displaying the analysis result on the user terminal, by comparing first resource information corresponding to the first user interface and second resource information corresponding to the second user interface for providing the analysis result. In case a difference exists between the first resource information and the second resource information, the processor 120 may provide the second resource information together with the analysis result.

The communication interface 130 may include a circuit, and perform communication with an external device. Specifically, the processor 120 may receive various types of data or information from an external device connected through the communication interface 130, or transmit various types of data or information to an external device.

The communication interface 130 may include at least one of a Wi-Fi module, a Bluetooth module, a wireless communication module, a near field communication (NFC) module, or an ultra-wide band (UWB) module. Specifically, a Wi-Fi module and a Bluetooth module may perform communication by a Wi-Fi method and a Bluetooth method, respectively. In the case of using a Wi-Fi module or a Bluetooth module, various types of connection information, such as a service set identifier (SSID), or the like, is transmitted and received first, and connection of communication is performed by using the information, and various types of information can be transmitted and received thereafter.

In addition, a wireless communication module may perform communication according to various communication standards, such as institute of electrical and electronics engineers (IEEE), Zigbee, 3^{rd} generation (3G), 3^{rd} generation partnership project (3GPP), long term evolution (LTE), 5^{th} generation (5G), or the like. In addition, an NFC module may perform communication by a near field communication (NFC) method using a 13.56 MHz band among various radio-frequency identification (RF-ID) frequency bands, such as 135kHz, 13.56 MHz, 433 MHz, 860-960 MHz, and 2.45GHz. Further, a UWB module can correctly measure a time of arrival (ToA) which is the time that a pulse reaches a target, and an Angle of Arrival (AoA) which is a pulse arrival angle in a transmission device through communication between UWB antennas, and accordingly, the UWB module can perform precise distance and location recognition in an error range of within scores of cm indoors.

According to an embodiment of the disclosure, the processor 120 may receive a request from a user terminal through the communication interface 130. When an analysis result is obtained, the processor 120 may control the communication interface 130 to transmit the analysis result to the user terminal.

In addition, according to an embodiment of the disclosure, in the case of displaying an analysis result on a user terminal, if it is identified that a change of the user interface is needed, the processor 120 may control the communication interface 130 to transmit resource information related to the configuration of the user interface to the user terminal.

The processor 120 may control the communication interface 130 to transmit a request for user information or data analysis to an external device storing a database, and receive the user information or an analysis result of data from the external device through the communication interface 130.

The processor 120 may control the communication interface 130 to transmit text information to an external device storing a language model, and receive information on the user's intent corresponding to the text information from the external device through the communication interface 130.

The processor 120 may control the communication interface 130 to transmit a request for an analysis result to an external device storing an analysis model, and receive the analysis result from the external device through the communication interface 130.

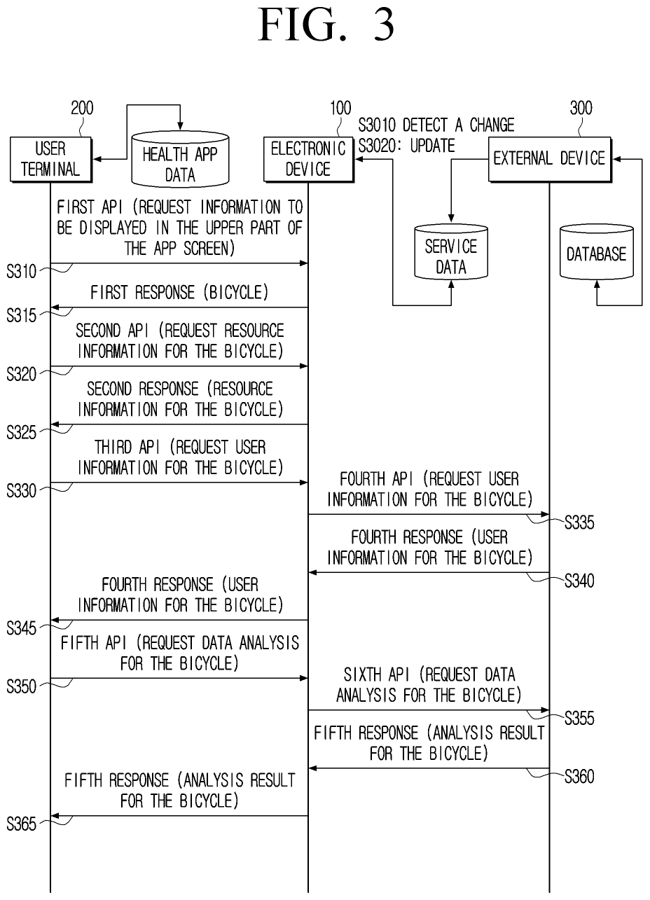

Various embodiments that are implemented as the processor 120 transmits and receives various types of requests, responses, information, or the like, with a user terminal and an external device by using the communication interface 130 will be described with reference to FIGS. 3 and 4.

The input interface 140 may include a circuit, and the processor 120 may receive a user instruction for controlling the operations of the electronic device 100 through the input interface 140. Specifically, the input interface 140 may consist of components, such as a microphone, a camera, and a remote control signal receiver, or the like. In addition, the input interface 140 may be implemented in a form of being included in a display as a touch screen. In particular, the microphone may receive a voice signal, and convert the received voice signal into an electric signal.

According to an embodiment of the disclosure, the processor 120 may receive a user input corresponding to a request for data analysis through the input interface 140. Other than that, the processor 120 may receive user inputs requesting to initiate the operations in the various embodiments according to the disclosure through the input interface 140.

The output interface 150 may include a circuit, and the processor 120 may output various functions that can be performed by the electronic device 100 through the output interface 150. In addition, the output interface 150 may include at least one of a display, a speaker, or an indicator.

The display may output image data by control by the processor 120. Specifically, the display may output an image stored in the memory 110 in advance by control by the processor 120. In particular, the display according to an embodiment of the disclosure may display a user interface stored in the memory 110. The display may be implemented as a liquid crystal display (LCD) panel, organic light emitting diodes (OLEDs), or the like. In addition, the display can be implemented as a flexible display, a transparent display, or the like. depending on cases. However, the display according to the disclosure is not limited to specific types.

The speaker may output audio data by control by the processor 120. The indicator may be turned on by control by the processor 120. Specifically, the indicator may be turned on in various colors according to control by the processor 120. For example, the indicator may be implemented as light emitting diodes (LEDs), a liquid crystal display (LCD) panel, a vacuum fluorescent display (VFD), or the like, but is not limited thereto.

According to an embodiment of the disclosure, the processor 120 may output subject data for analysis, an identification result for an algorithm and a schema, and an analysis result related to the subject data for analysis through the output interface 150.

According to the embodiments of the disclosure described above with reference to FIGS. 1 and 2, the electronic device 100 can dynamically identify subject data for analysis used in data analysis and an algorithm used in the data analysis according to a request for data analysis, and automatically reflect an analysis result obtained based on the identified subject data for analysis and algorithm to a service provided to a user.

In particular, in case a service to be provided to a user is changed, a data analysis algorithm or model is changed, a database is changed, or an analysis result of data is changed, the electronic device 100 can automatically identify subject data for analysis, an algorithm, and a schema corresponding to the automatically changed service, and obtain an analysis result in accordance thereto and provide a service.

In addition, the electronic device 100 can perform data analysis and provision of an analysis result while minimizing changes of applications provided to a user and changes of programs for providing services according to differences between formats and collection methods of data among services.

FIG. 3 is a diagram illustrating a method of providing an analysis result according to an embodiment of the disclosure.

Referring to FIG. 3, a method of providing an analysis result according to the disclosure will be explained on the premise that a health application (app) for a user is executed by a user terminal 200, and an analysis result according to data analysis is provided through the health app.

In addition, in FIG. 3, ‘health app data’ generally refers to data for executing a health app in a user terminal 200, and ‘service data’ is data in a format defined for providing a plurality of services related to an analysis result to a user, and generally refers to data stored in the electronic device 100.

According to the disclosure, ‘an external device’ refers to a device that stores and manages a database. Service data and a database may be stored and managed by the electronic device 100 which is one device, but in FIG. 3 and explanation regarding FIG. 3, an embodiment wherein service data is stored and managed by the electronic device 100, and a database is stored and managed by an external device 300 will be explained.

The electronic device 100 may receive a request for data analysis, and such a request may be sequentially received according to a plurality of APIs as illustrated in FIG. 3. For example, in FIG. 3, the plurality of application programming interfaces (APIs) which are a first API to a fourth API refer to APIs set in advance to correspond to a request for data analysis. In addition, in FIG. 3, a response is a response for an API, and may include an analysis result and information for displaying the analysis result on an app screen, or the like. A first response to a fourth response in FIG. 3 refer to responses respectively corresponding to the first API to the fourth API.

Referring to FIG. 3, the electronic device 100 may receive the first API from a user terminal 200 in operation S310. For example, the first API may include a request for information to be displayed on an application (app) screen of the user terminal 200.

When the first API is received, the electronic device 100 may transmit the first response to the user terminal 200 in operation S315. For example, in case the first API is an API requesting information to be displayed in the upper part of the app screen of the user terminal 200, the first response may indicate that the information to be displayed in the upper part of the app screen of the user terminal 200 is information on “a bicycle.”

After transmitting the first response, the electronic device 100 may receive the second API from the user terminal 200 in operation S320. For example, the second API may include a request for resource information for the bicycle. As described above, ‘resource information’ refers to information related to the configuration of a user interface, and specifically, it may indicate which information is displayed in which location of a user interface for providing information on the bicycle.

When the second API is received, the electronic device 100 may transmit the second response to the user terminal 200 in operation S325. For example, the second response may include information indicating that the type of the user interface is ‘the bicycle,’ information indicating that the display range of the information is ‘the last week,’ and resource information for providing information on the bicycle.

After transmitting the second response, the electronic device 100 may receive the third API from the user terminal 200 in operation S330. For example, the third API may include a request for user information for the bicycle. Specifically, the third API may include a request for information on the history that the user of the user terminal 200 used the bicycle.

When the third API is received, the electronic device 100 may transmit the fourth API to an external device 300 in operation S335. For example, the fourth API may include identification information of the user of the user terminal 200 (e.g., the identification (ID) of the user) and period information (e.g., the second week of September), or the like.

After transmitting the fourth API, the electronic device 100 may receive the fourth response from the external device 300 in operation S340. Thereafter, when the fourth response is received, the electronic device 100 may transmit the fourth response to the user terminal 200 in operation S345. For example, the fourth response may include information that the driving distance of the user of the user terminal 200 on the second week of September is 5 km, and information that the driving time is 60 minutes. In case resource information was not transmitted to the user terminal 200 according to the second API and the second response, the fifth response may include resource information related to providing the information included in the fourth response.

After transmitting the fourth response, the electronic device 100 may receive the fifth API from the user terminal 200 in operation S350. For example, the fifth API may include a request for analysis of the data for the bicycle. Specifically, the fifth API may include a request for analysis of data for statistical information, such as bicycle driving records of other users of the same age group and the same sex as the user.

Although not illustrated in FIG. 3, as explained with reference to FIG. 1, if a request for data analysis is received as the fifth API is received, the electronic device 100 may identify subject data for analysis corresponding to the request for data analysis and an algorithm used in the data analysis, and identify a schema corresponding to the subject data for analysis among the plurality of schemas related to the structure of a database constructed in advance.

When the subject data for analysis, an algorithm, and a schema are identified, the electronic device 100 may transmit the sixth API to the external device 300 in operation S355. Specifically, the sixth API may include a request for analysis of the data for the bicycle, and may include a request for analysis of data for statistical information, such as bicycle driving records of other users of the same age group and the same sex as the user. In addition, the sixth API may include information on at least one of the identified subject data for analysis, the identified algorithm, or the identified schema.

In addition, the sixth API may include metadata for referring to the database. Here, ‘the metadata’ may include information regarding which data included in the database will be referred to for obtaining an analysis result. For example, the sixth API may include identification information of a user of a user terminal 200 (e.g., the ID of the user), period information (e.g., the second week of September), information on bicycle driving records of other users of the same age group and the same sex as the user, information on a comparison result of driving records between the user and the other users, or the like.

After transmitting the sixth API, the electronic device 100 may receive the fifth response from the external device 300 in operation S360. When the fifth response is received, the electronic device 100 may transmit the fifth response to the user terminal 200 in operation S365. For example, the fifth response may include an analysis result for the bicycle. Specifically, the fifth response may include information that the average driving distance of other users of the same age group and the same sex as the user is 5.6 km, information that the average driving time of the other users is 63 minutes, information that the average heart rate of the other users when driving is 150, information on a comparison result of driving records between the user of the user terminal 200 and the other users, or the like.

Meanwhile, the database may be continuously updated, and accordingly, an analysis result related to the same subject data for analysis may also be changed. In addition, when an analysis result is changed, service data for providing the analysis result may also be changed.

Change of an analysis result according to update of the database and change of the service data in accordance thereto may be manually performed by a data scientist or a system manager, but it may also be automatically performed by the electronic device 100 according to the disclosure and/or an external device 300. Hereinafter, embodiments performed by the electronic device 100 will be explained.

According to an embodiment of the disclosure, the electronic device 100 may detect a change for the database in operation S3010. Specifically, the electronic device 100 may detect a change for the database by monitoring the database per predetermined period, or transmitting a request for monitoring to the external device 300. Here, a change of the database may include addition, deletion, and exchange, or the like, of the data.

When a change for the database is detected, the electronic device 100 may update the service data for a plurality of services in operation S3020. Specifically, the electronic device 100 may obtain an analysis result which has schemas corresponding to the plurality of services based on the changed database. Then, the electronic device 100 may update the service data based on the analysis result.

For example, the database may be managed as a schema-less structure which does not use a fixed schema when storing data, and in case the database is changed, the electronic device 100 may generate service data corresponding to each of the plurality of schemas by referring to a table defining schemas, and store the generated service data.

Then, when one service among the plurality of services is changed, the electronic device 100 may dynamically identify a schema corresponding to the changed service among the plurality of schemas, and provide a service related to the analysis result by using the service data generated to correspond to the identified schema.

According to the aforementioned embodiment of the disclosure, resource information which is information related to the structure of the user interface is not stored in a user terminal, and even if a service to be provided to a user is changed, the electronic device 100 may transmit resource information which is information related to the structure of the user interface to the user terminal together with an analysis result for the changed service.

In addition, in case the database is changed, the electronic device 100 may dynamically detect the change of the database, and automatically reflect the change of the database to the service data effectively.

Accordingly, even if the database is changed, the electronic device 100 can automatically reflect the change of the database to service data for providing a service, without the developer having to manually change the content and the schema of the service data for providing a service, and update an application provided to the user for reflecting the change, and update data or a program for implementing the service at a server, and can thereby provide a data analysis result appropriate for the provided service.

For example, in case information on “a pedometer” was being provided in the upper part of the screen of a health app, and then the information to be provided in the upper part of the screen of the health app is changed to information on “a bicycle” by the user or the service provider, the electronic device 100 can provide an analysis result related to subject data for analysis by providing an analysis result that has a schema for providing information on the bicycle by interlocking it with an API.

FIG. 4 is a diagram illustrating a method of providing an analysis result by using a language model 1000 and an analysis model 2000 according to an embodiment of the disclosure.

Referring to FIG. 4, the electronic device 100 may receive a request for data analysis, and the request for data analysis may include text information in operation S410. Here, the text information may be text information input by a user, and may be text information obtained based on a user voice.

For example, in case text information was obtained based on a user voice, the electronic device 100 may obtain text information corresponding to the user voice by obtaining the user voice, and inputting the user voice into the voice recognition model. In addition, a voice recognition process may be performed by a user terminal, and the electronic device 100 may receive text information corresponding to a user voice from the user terminal.

If the text information includes information on an algorithm in operation S420-Y, the electronic device 100 may identify subject data for analysis and an algorithm used in the data analysis based on the text information in operations S450 and S460.

Specifically, if the text information includes information on one algorithm among a plurality of pre-defined algorithms, the electronic device 100 may identify the one algorithm as the algorithm used in the data analysis. For example, in case the text information is “Please calculate my health score by using the algorithm A,” the electronic device 100 may identify the algorithm A as the algorithm used in the data analysis.

If the text information does not include information on an algorithm in operation S420-N, the electronic device 100 may input the text information into a language model 1000 in operation S430, and obtain information on the user's intent in operation S440.

‘The language model’ may perform natural language processing for the input text information, and understand the context and the structure of the input text information, and obtain information on the user's intent corresponding to the text information. Specifically, the language model 1000 may divide the text information input by the user into a plurality of words or tokens which are smaller units than words, and convert each token into an embedding vector, and classify the embedding vectors into a plurality of pre-defined intent categories, and may thereby obtain information on the user's intent.

For example, the language model 1000 may be a large language model (LLM) that performs natural language understanding and generation by learning a vast amount of text data, and it may also be a neural network model trained to identify an algorithm and/or subject data for analysis corresponding to input text information. However, there is no special limitation on the type of the language model 1000 according to the disclosure.

Specifically, if the text information does not include information on one algorithm among the plurality of algorithms, the electronic device 100 may input the text information into the trained language model 1000, and obtain information on the user's intent included in the text information.

When the information on the user's intent is obtained, the electronic device 100 may identify subject data for analysis and an algorithm used in the data analysis based on the information on the user's intent in operations S450 and S460.

According to an embodiment of the disclosure, the electronic device 100 may identify subject data for analysis based on the information on the user's intent in operation S450. For example, in case the text information is “Please calculate my health score by using the algorithm A,” the electronic device 100 may identify at least some of the data regarding the operation count, the health record, the sleeping time, the food taken, the weight, the body composition, the heart rate, or the like, of the user as the subject data for analysis. Here, the operation count, the health record, the sleeping time, the food taken, the weight, the body composition, the heart rate, or the like, of the user may be data that was set to be related to a health score, or was set to be related to a health-related application.

As another example, in case the text information is “Please calculate my health score without considering the sleeping record during five days,” the electronic device 100 may input the text information into the trained language model, and identify at least some of the remaining data excluding the data for the sleeping time during the last five days in the data related to the health score in the aforementioned example as the subject data for analysis.

According to an embodiment of the disclosure, the electronic device 100 may identify an algorithm used in the data analysis based on the information on the user's intent in operation S460. For example, in case the text information is “Please calculate my health score by a recent method,” the electronic device 100 may input the text information into the trained language model, and identify an algorithm C which is the most recent algorithm among the plurality of algorithms that can be used by the electronic device 100 as the algorithm used in the data analysis.

Meanwhile, the electronic device 100 may input a request for an analysis result into an analysis model 2000 in operation S470, and obtain an analysis result in operation S480. Then, when the analysis result is obtained, the electronic device 100 may provide the analysis result to the user terminal in operation S490.

Specifically, the electronic device 100 may identify an analysis model 2000 corresponding to the identified algorithm among the plurality of analysis models, and input a request for an analysis result into the identified analysis model 2000. For example, a request for an analysis result may include information on the request for data analysis, the identified subject data for analysis, and the identified algorithm. Although not illustrated in FIG. 4, a request for an analysis result may also include information on the identified schema.

Meanwhile, the language model 1000 and the analysis model 2000 in FIG. 4 may be models stored in the electronic device 100, or models stored in at least one external device. For example, the language model 1000 may be stored in a first external device, and the analysis model 2000 may be stored in a second external device, and in this case, the electronic device 100 may transmit the text information to the first external device, and receive the information on the user's intent from the first external device. In addition, the electronic device 100 may transmit a request for an analysis result to the second external device, and receive the analysis result from the second external device.

Meanwhile, in FIG. 4, a case wherein the language model 1000 and the analysis model 2000 are implemented as separate neural network models was illustrated as an example, but the disclosure is not limited thereto. In particular, in case the language model 1000 is a large language model (LLM), the language model 1000 and the analysis model 2000 may be implemented as one integrated neural network model, and may perform both an operation of obtaining information on the user's intent corresponding to text information, and an operation of obtaining an analysis result based on subject data for analysis and information on a schema.

According to the embodiments described above with reference to FIG. 4, the electronic device 100 may dynamically identify subject data for analysis and an algorithm by using the language model 1000, and obtain an analysis result by using an analysis model 2000 corresponding to the identified algorithm.

In particular, in the past, in case a database was changed, a process of reflecting the change to service data was performed by a manual work of the developer or the manager, and thus there was a limitation that it is difficult to interlock an analysis result with a neural network model. However, the electronic device 100 according to the disclosure automatically detects a change of a database and reflects the change to service data, and thus it can provide an analysis result by utilizing a neural network model that fits a method desired by a user in a pluggable way.

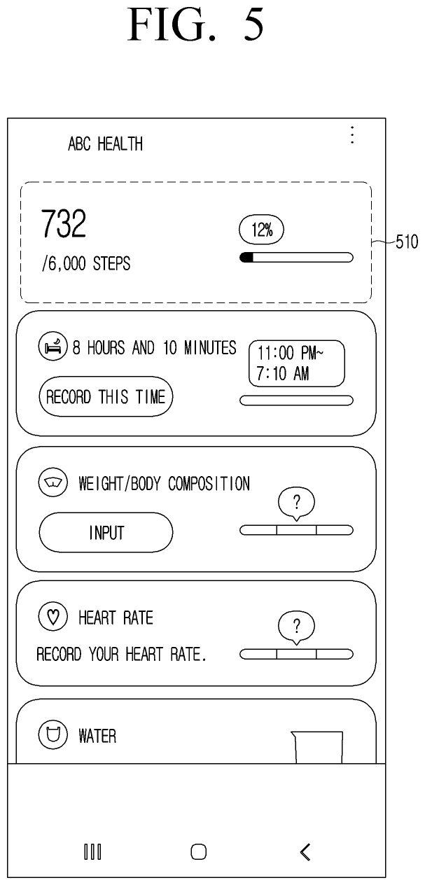

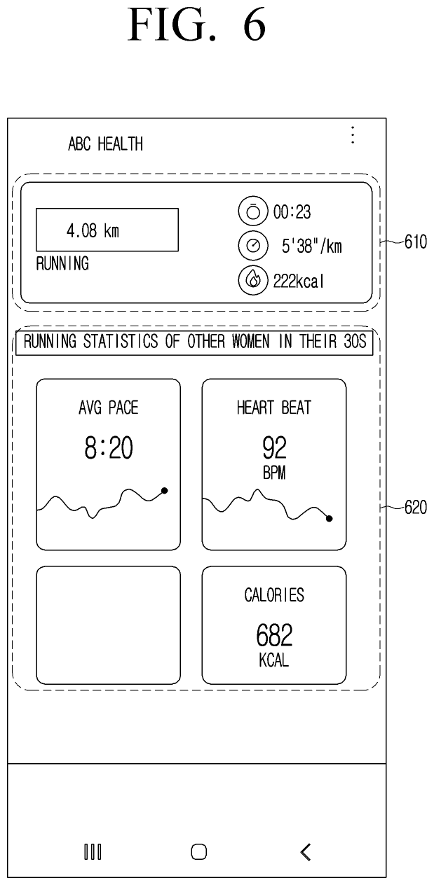

FIGS. 5 and 6 are diagrams illustrating a user interface according to various embodiments of the disclosure.

FIG. 5 indicates a user interface that displays information on “a pedometer” in the upper part of the screen of an app which is “ABC health.” Referring to FIG. 5, the information displayed on the app screen may include information on the user. In addition, as illustrated in an area 510 in FIG. 5, the information on the pedometer may include information that the operation count of the user today is 732, the target operation count of the user is 6,000, and the target achievement rate is 12%.

FIG. 6 illustrates a user interface that displays information on “running” in the upper part of the screen of the app which is “ABC health.” Referring to FIG. 6, the information displayed on the app screen may include an analysis result together with the information on the user.

As illustrated in an area 610 in FIG. 6, the information on running may include information that the running distance of the user today is 4.08 km, information that the running time is 23 minutes, the pace in a km unit is 5 minutes and 38 seconds, and the consumed calories are 222 kcal.

In addition, as illustrated in an area 620 in FIG. 6, the information on running may include statistical information regarding running records of other users of the same sex (female) and the same age group (thirties) as the user. For example, the information on running may include information that the average pace of the other users is 8 minutes and 20 seconds, the heart rate of the other users is 92 bpm, and the total consumed calories of the other users are 682 kcal.

Further, although not illustrated in FIG. 6, the information on running may include various types of analysis results, such as a comparison result of the running records of the user and the other users, and information on re-adjustment of the target according to the comparison result, or the like.

According to an embodiment of the disclosure, in case an analysis result is displayed on a user terminal, the electronic device 100 may identify whether a change of the user interface (UI) is needed. Then, if it is identified that a change of the user interface is needed, the electronic device 100 may obtain resource information related to the configuration of the user interface, and transmit the resource information to the user terminal.

For example, while a first user interface (e.g., the user interface in FIG. 5) is being displayed on the user terminal, if a request for data analysis is received, the electronic device 100 may compare first resource information corresponding to the first user interface and second resource information corresponding to a second user interface (e.g., the user interface in FIG. 6) for providing an analysis result, and thereby identify whether a change of the user interface is needed in the case of displaying the analysis result on the user terminal. In case a difference exists between the first resource information and the second resource information, the electronic device 100 may transmit the second resource information to the user terminal.

According to the embodiments described above with reference to FIG. 5, even if a service to be provided to the user is changed as in a case wherein information on “a pedometer” is provided as in FIG. 5, and then information on “running” is provided as in FIG. 5, the electronic device 100 may transmit resource information which is information related to the configuration of the user interface to the user terminal together with an analysis result for the changed service.

Accordingly, the electronic device 100 can update an application provided to the user in spite of the change of the service, and can provide a service appropriate for the user without having to update data or a program for implementing the service at the server.

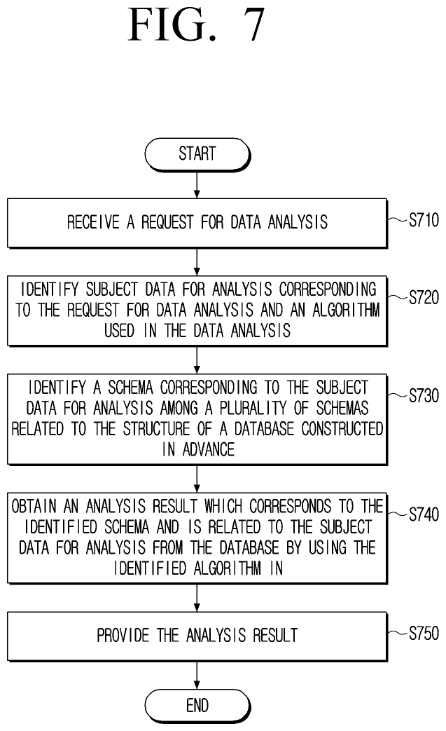

FIG. 7 is a diagram illustrating a controlling method of an electronic device according to an embodiment of the disclosure.

Referring to FIG. 7, the electronic device 100 may receive a request for data analysis in operation S710. Specifically, the electronic device 100 may receive a request for data analysis based on a predetermined event that occurred in the electronic device 100, or receive a request for data analysis from a user terminal. A request for data analysis received from a user terminal may be a request according to a user input, or a request according to a pre-defined application programming interface (API).

The electronic device 100 may identify subject data for analysis corresponding to the request for data analysis and an algorithm used in the data analysis in operation S720.

Specifically, based on the request for data analysis, the electronic device 100 may identify what the subject data for analysis is, and also identify an algorithm appropriate for performing data analysis according to the request among a plurality of pre-defined algorithms.

According to an embodiment of the disclosure, in case the request for data analysis includes text information input by the user, the electronic device 100 may identify subject data for analysis and an algorithm used in the data analysis based on the text information.

Meanwhile, the electronic device 100 may obtain information on the user's intent included in the text information by inputting the text information into the trained language model, and identify data corresponding to the request for data analysis, i.e., the subject data for analysis based on the information on the user's intent.

The electronic device 100 may identify a schema corresponding to the subject data for analysis among a plurality of schemas related to the structure of a database constructed in advance in operation S730. Specifically, the electronic device 100 may identify a schema including attributes related to the subject data for analysis among the plurality of schemas.

The electronic device 100 may obtain an analysis result which corresponds to the identified schema and is related to the subject data for analysis from the database by using the identified algorithm in operation S740. Then, the electronic device 100 may provide the analysis result in operation S750.

Specifically, the electronic device 100 may identify data having the schema identified in the database constructed in advance, and obtain an analysis result by using the relation between the data having the identified schema and the subject data for analysis.

In the disclosure, what kind of analysis result will be obtained by using what kind of analysis method may vary according to an algorithm used in the data analysis, and in the case of implementing an algorithm by using a neural network model, it may vary according to the neural network model, i.e., an analysis model.

Specifically, the electronic device 100 may obtain an analysis result by inputting the subject data for analysis and information on the identified schema into an analysis model corresponding to the identified algorithm among a plurality of analysis models. ‘The analysis model’ may be trained to, if subject data for analysis and information on an identified schema are input, obtain an analysis result by referring to the database. However, there is no special limitation on the type of the analysis model according to the disclosure.

Meanwhile, the controlling method of the electronic device 100 according to the aforementioned embodiment can be implemented as a program and provided to the electronic device 100. In particular, a program including the controlling method of the electronic device 100 can be provided while being stored in a non-transitory computer readable medium.

Specifically, in a non-transitory computer readable recording medium including a program executing the controlling method of the electronic device 100, the controlling method of the electronic device 100 may include the operations of, based on receiving a request for data analysis, identifying subject data for analysis corresponding to the request and an algorithm used in the data analysis, identifying a schema corresponding to the subject data for analysis among a plurality of schemas related to a structure of a database constructed in advance, obtaining an analysis result that corresponds to the identified schema and is related to the subject data for analysis from the database by using the identified algorithm, and providing the analysis result.

In the above, a controlling method of the electronic device 100, and a computer readable recording medium including a program executing the controlling method of the electronic device 100 were explained briefly, but this is just for omitting overlapping explanation, and the various embodiments regarding the electronic device 100 can obviously be applied to the controlling method of the electronic device 100, and the computer readable recording medium including a program executing the controlling method of the electronic device 100.

Functions related to artificial intelligence according to the disclosure are operated through the processor 120 and the memory 110 of the electronic device 100.

The processor 120 may consist of one or a plurality of processors 120. Here, the one or plurality of processors may include at least one of a central processing unit (CPU), a graphics processing unit (GPU), or a neural processing unit (NPU), but the processors are not limited to the aforementioned examples of the processors 120.

A CPU is a generic-purpose processor 120 that can perform not only general operations but also artificial intelligence operations, and it can effectively execute a complex program through a multilayer cache structure. A CPU is advantageous for a serial processing method that enables a systemic linking between the previous calculation result and the next calculation result through sequential calculations. The generic-purpose processor 120 is not limited to the aforementioned examples excluding cases wherein it is specified as the aforementioned CPU.

A GPU is a processor 120 for mass operations, such as a floating point operation used for graphic processing, or the like, and it can perform mass operations in parallel by massively integrating cores. More particularly, a GPU may be advantageous for a parallel processing method, such as a convolution operation, or the like, compared to a CPU. In addition, a GPU may be used as a co-processor 120 for supplementing the function of a CPU. The processor 120 for mass operations is not limited to the aforementioned examples excluding cases wherein it is specified as the aforementioned GPU.

An NPU is a processor 120 specialized for an artificial intelligence operation using an artificial neural network, and it can implement each layer constituting an artificial neural network as hardware (e.g., silicon). Here, the NPU is designed to be specialized according to the required specification of a company, and thus it has a lower degree of freedom compared to a CPU or a GPU, but it can effectively process an artificial intelligence operation required by the company. Meanwhile, as the processor 120 specialized for an artificial intelligence operation, an NPU may be implemented in various forms, such as a tensor processing unit (TPU), an intelligence processing unit (IPU), a vision processing unit (VPU), or the like. The artificial intelligence processor 120 is not limited to the aforementioned examples excluding cases wherein it is specified as the aforementioned NPU.

In addition, the one or plurality of processors 120 may be implemented as a system on chip (SoC). Here, in the SoC, the memory 110, and a network interface, such as a bus for data communication between the processor 120 and the memory 110, or the like, may be further included other than the one or plurality of processors 120.

In case the plurality of processors 120 are included in the system on chip (SoC) included in the electronic device 100, the electronic device 100 may perform an operation related to artificial intelligence (e.g., an operation related to learning or inference of the artificial intelligence model) by using some processors 120 among the plurality of processors 120. For example, the electronic device 100 may perform an operation related to artificial intelligence by using at least one of a GPU, an NPU, a, VPU, a TPU, or a hardware accelerator specified for artificial intelligence operations such as a convolution operation, a matrix product operation, or the like, among the plurality of processors 120. However, this is merely an example, and the electronic device 100 can obviously process an operation related to artificial intelligence by using the generic-purpose processor 120, such as a CPU, or the like.

In addition, the electronic device 100 may perform operations regarding functions related to artificial intelligence by using a multicore (e.g., a dual core, a quad core, or the like) included in one processor 120. More particularly, the electronic device 100 may perform artificial intelligence operations, such as a convolution operation, a matrix product operation, or the like, in parallel by using the multicore included in the processor 120.

The one or plurality of processors 120 may perform control to process input data according to pre-defined operation rules or an artificial intelligence model stored in the memory 110. The pre-defined operation rules or the artificial intelligence model are characterized in that they are made through learning.

Here, being made through learning means that a learning algorithm is applied to a plurality of training data, and pre-defined operation rules or an artificial intelligence model having desired characteristics are thereby made. Such learning may be performed in a device itself wherein artificial intelligence is performed according to the disclosure, or through a separate server/system.

An artificial intelligence model may consist of a plurality of neural network layers. At least one layer has at least one weight value, and performs an operation of the layer through an operation result of the previous layer and at least one defined operation. As examples of a neural network, there are a convolutional neural network (CNN), a deep neural network (DNN), a recurrent neural network (RNN), a restricted Boltzmann Machine (RBM), a deep belief network (DBN), a bidirectional recurrent deep neural network (BRDNN), deep Q-networks, and a Transformer, but the neural network in the disclosure is not limited to the aforementioned examples excluding specified cases.

A learning algorithm is a method of training a specific subject device (e.g., a robot) by using a plurality of training data and thereby making the specific subject device make a decision or make prediction by itself. As examples of learning algorithms, there are supervised learning, unsupervised learning, semi-supervised learning, or reinforcement learning, but learning algorithms in the disclosure are not limited to the aforementioned examples excluding specified cases.

Meanwhile, a storage medium readable by machines may be provided in the form of a non-transitory storage medium. Here, the term ‘a non-transitory storage medium’ only means that a storage medium is a tangible device, and does not include signals (e.g., electromagnetic waves), and the term does not distinguish a case wherein data is stored in the storage medium semi-permanently and a case wherein data is stored temporarily. For example, ‘a non-transitory storage medium’ may include a buffer wherein data is temporarily stored.

In addition, according to an embodiment of the disclosure, the method according to the various embodiments disclosed herein may be provided while being included in a computer program product. A computer program product refers to a product, and it can be traded between a seller and a buyer. A computer program product can be distributed in the form of a storage medium that is readable by machines (e.g., compact disc read only memory (CD-ROM)), or distributed on-line (e.g., download or upload) through an application store (e.g., Play Store™) or directly between two user devices (e.g., smartphones). In the case of on-line distribution, at least a portion of a computer program product (e.g., a downloadable app) may be stored in a storage medium, such as the server of the manufacturer, the server of the application store, and the memory 110 of the relay server at least temporarily, or may be generated temporarily.

In addition, each of the components (e.g., a module or a program) according to the aforementioned various embodiments of the disclosure may consist of a singular object or a plurality of objects. In addition, among the aforementioned corresponding sub components, some sub components may be omitted, or other sub components may be further included in the various embodiments. Alternatively or additionally, some components (e.g., a module or a program) may be integrated as an object, and perform functions that were performed by each of the components before integration identically or in a similar manner.

Further, operations performed by a module, a program, or other components according to the various embodiments may be executed sequentially, in parallel, repetitively, or heuristically. Alternatively, at least some of the operations may be executed in a different order or omitted, or other operations may be added.

Meanwhile, the term “a part” or “a module” used in the disclosure may include a unit implemented as hardware, software, or firmware, and may be interchangeably used with, for example, terms, such as a logic, a logical block, a component, or a circuit. In addition, “a part” or “a module” may be a component constituted as an integrated body or a minimum unit or a part thereof performing one or more functions. For example, a module may be constituted as an application-specific integrated circuit (ASIC).

In addition, the various embodiments of the disclosure may be implemented as software including instructions stored in machine-readable storage media, which can be read by machines (e.g., computers). The machines refer to devices that call instructions stored in a storage medium, and can operate according to the called instructions, and the devices may include an electronic device according to the aforementioned embodiments (e.g., the electronic device 100).

In case an instruction is executed by a processor, the processor may perform a function corresponding to the instruction by itself, or by using other components under its control. An instruction may include a code that is generated or executed by a compiler or an interpreter.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory, comprising one or more storage media, storing instructions; and
at least one processor communicatively coupled to the memory,
wherein the instructions, when executed by the at least one processor individually or collectively cause the electronic device to:
based on receiving a request for data analysis, identify subject data for analysis corresponding to the request and an algorithm used in the data analysis,
identify a schema corresponding to the subject data for analysis among a plurality of schemas related to a structure of a database constructed in advance,
obtain an analysis result that corresponds to the identified schema and is related to the subject data for analysis from the database by using the identified algorithm, and
provide the analysis result.

2. The electronic device of claim 1,
wherein the request comprises:
text information input by a user, and
wherein the instructions, when executed by the at least one processor individually or collectively further cause the electronic device to:
identify the subject data for analysis and the algorithm used in the data analysis based on the text information.

3. The electronic device of claim 2, wherein the instructions, when executed by the at least one processor individually or collectively further cause the electronic device to:
based on the text information including information on one algorithm among a plurality of pre-defined algorithms, identify the one algorithm as the algorithm used in the data analysis,
based on the text information not including information on one algorithm among the plurality of algorithms, obtain information on the user's intent included in the text information by inputting the text information into a trained language model, and
based on the information on the user's intent, identify the algorithm used in the data analysis.

4. The electronic device of claim 3, wherein the instructions, when executed by the at least one processor individually or collectively further cause the electronic device to:
based on the information on the user's intent, identify data corresponding to the request.

5. The electronic device of claim 1,
wherein the plurality of algorithms are performed by a plurality of analysis models including a neural network, and
wherein the instructions, when executed by the at least one processor individually or collectively further cause the electronic device to:
obtain the analysis result by inputting information on the subject data for analysis and the identified schema into an analysis model corresponding to the identified algorithm among the plurality of analysis models.

6. The electronic device of claim 1, further comprising:
a communication interface,
wherein the instructions, when executed by the at least one processor individually or collectively further cause the electronic device to:
receive the request from a user terminal through the communication interface, and
based on obtaining the analysis result, provide the analysis result by controlling the communication interface to transmit the analysis result to the user terminal.

7. The electronic device of claim 6, wherein the instructions, when executed by the at least one processor individually or collectively further cause the electronic device to:
obtain resource information related to a configuration of a user interface for displaying the analysis result on the user terminal, and
control the communication interface to transmit the resource information to the user terminal.

8. The electronic device of claim 7,
wherein the plurality of schemas correspond to at least one of a plurality of services provided through the user terminal, and
wherein the instructions, when executed by the at least one processor individually or collectively further cause the electronic device to:
based on detecting a change for the database, update service data for the plurality of services by generating data corresponding to each of the plurality of schemas based on the changed database.

9. A method of controlling an electronic device, the method comprising:
based on receiving a request for data analysis, identifying subject data for analysis corresponding to the request and an algorithm used in the data analysis;
identifying a schema corresponding to the subject data for analysis among a plurality of schemas related to a structure of a database constructed in advance;
obtaining an analysis result that corresponds to the identified schema and is related to the subject data for analysis from the database by using the identified algorithm; and
providing the analysis result.

10. The method of claim 9,
wherein the request comprises:
text information input by a user, and
wherein the identifying of the subject data for analysis and the algorithm comprises:
identifying the subject data for analysis and the algorithm used in the data analysis based on the text information.

11. The method of claim 10, wherein the identifying of the subject data for analysis and the algorithm comprises:
based on the text information including information on one algorithm among a plurality of pre-defined algorithms, identifying the one algorithm as the algorithm used in the data analysis;
based on the text information not including information on one algorithm among the plurality of algorithms, obtaining information on the user's intent included in the text information by inputting the text information into a trained language model; and
based on the information on the user's intent, identifying the algorithm used in the data analysis.

12. The method of claim 11, wherein the identifying of the subject data for analysis and the algorithm comprises:
based on the information on the user's intent, identifying data corresponding to the request.

13. The method of claim 9,
wherein the plurality of algorithms are performed by a plurality of analysis models including a neural network, and
wherein the obtaining of the analysis result comprises:
obtaining the analysis result by inputting information on the subject data for analysis and the identified schema into an analysis model corresponding to the identified algorithm among the plurality of analysis models.

14. The method of claim 9, further comprising:
receiving the request from a user terminal, and
wherein the providing of the analysis result comprises:
based on obtaining the analysis result, transmitting the analysis result to the user terminal.

15. The method of claim 14, further comprising:
obtaining resource information related to a configuration of a user interface for displaying the analysis result on the user terminal; and
transmitting the resource information to the user terminal.

16. The method of claim 15,
wherein the plurality of schemas correspond to at least one of a plurality of services provided through the user terminal, and
wherein the method further comprises:
based on detecting a change for the database, updating service data for the plurality of services by generating data corresponding to each of the plurality of schemas based on the changed database.

17. One or more non-transitory computer-readable storage media storing one or more computer programs including computer-executable instruction that, when executed by one or more processors of an electronic device individually or collectively, cause the electronic device to perform operations, the operations comprising:
based on receiving a request for data analysis, identifying subject data for analysis corresponding to the request and an algorithm used in the data analysis;
identifying a schema corresponding to the subject data for analysis among a plurality of schemas related to a structure of a database constructed in advance;
obtaining an analysis result that corresponds to the identified schema and is related to the subject data for analysis from the database by using the identified algorithm; and
providing the analysis result.

18. The one or more non-transitory computer-readable storage media of claim 17,
wherein the request comprises:
text information input by a user, and
wherein the identifying of the subject data for analysis and the algorithm comprises:
identifying the subject data for analysis and the algorithm used in the data analysis based on the text information.

19. The one or more non-transitory computer-readable storage media of claim 18, wherein the identifying of the subject data for analysis and the algorithm comprises:
based on the text information including information on one algorithm among a plurality of pre-defined algorithms, identifying the one algorithm as the algorithm used in the data analysis;
based on the text information not including information on one algorithm among the plurality of algorithms, obtaining information on the user's intent included in the text information by inputting the text information into a trained language model; and
based on the information on the user's intent, identifying the algorithm used in the data analysis.

20. The one or more non-transitory computer-readable storage media of claim 19, wherein the identifying of the subject data for analysis and the algorithm comprises:
based on the information on the user's intent, identifying data corresponding to the request.
